(19) United States
(12) Patent Application Publication
(10) Pub. No.: US 2023/0274305 A1
(43) Pub. Date: Aug. 31, 2023

(54) METHODS FOR PROVIDING DECENTRALIZED PRODUCT AND REWARDS DELIVERY PLATFORM

(71) Applicant: Benjamin Yeung, Bradbury, CA (US)

(72) Inventor: Benjamin Yeung, Bradbury, CA (US)

(21) Appl. No.: 18/114,366

(22) Filed: Feb. 27, 2023

Related U.S. Application Data
(60) Provisional application No. 63/314,916, filed on Feb. 28, 2022.

(51) Int. Cl. G06Q 30/0207; G06Q 20/38; G06Q 20/12; G06Q 20/36; G06Q 30/0226; G06Q 30/0601; G06Q 30/08; G06Q 40/06; G06Q 40/04

(52) U.S. Cl. CPC G06Q 30/0222; G06Q 20/389; G06Q 20/1235; G06Q 20/3672; G06Q 30/0233; G06Q 30/0231; G06Q 30/0212; G06Q 30/0635; G06Q 20/3678; G06Q 30/08; G06Q 40/06; G06Q 40/04

(57) ABSTRACT

Methods for providing decentralized product and rewards delivery platform are provided. The method includes: issuing, by an asset management unit, a number of fungible tokens according to a number of products related to the company in a predetermined period of time provided by the company; distributing the fungible tokens into wallets of users who purchase one of the products of the company from a platform; issuing drawing tickets to the wallets of the users who redeem the fungible tokens, where the drawing tickets are automatically entered into a rewards pool for drawing; drawing rewards in the rewards pool to determine winners from the users who have the drawing tickets, according to reward rules; and issuing the rewards using smart contracts and depositing the rewards into wallets of the winners. The winners redeem the rewards by claiming the drawing tickets in their wallets.

### CROSS-REFERENCE TO RELATED PATENT APPLICATIONS

This non-provisional application claims priority to and the benefit of, pursuant to 35 U.S.C. § 119(e), U.S. provisional patent application Ser. No. 63/314,916, filed Feb. 28, 2022, entitled “DECENTRALIZED PRODUCT AND REWARDS DELIVERY PLATFORM,” by Benjamin Yeung, which is incorporated herein in its entirety by reference.

This non-provisional application relates to co-pending U.S. patent application, entitled “SYSTEMS FOR DECENTRALIZED PRODUCT AND REWARDS DELIVERY PLATFORM,” concurrently filed on Feb. 27, 2023. The entire content of the above identified application is incorporated herein by reference.

### FIELD OF THE INVENTION

This invention relates generally to electronic devices, and more particularly to methods performed by the electronic devices for providing decentralized product and rewards delivery platform.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

It is known that the Internet has facilitated business-to-business (or “B2B”) markets as well as business-to-consumer (or “B2C”) markets, for instance, those in which business transactions may be negotiated and agreed electronically, and all kinds of products and services may be purchased on-line. Computers and their operations provide a significant part of the infrastructure of an on-line B2B and B2C marketplace, and facilitate transactions in those markets with efficiencies previously unforeseen, which in turn continuously fuels new innovations in relation to the Internet.

One such relatively new innovative technology is so called blockchain technology that has been used in digital currency implementations. Blockchain utilizes a data structure that stores a list of transactions and can be considered of as a distributed electronic ledger that records transactions between source identifier(s) and destination identifier(s). The transactions are bundled into blocks and every block (except for the first block) refers back to or is linked to a prior block in the blockchain. Computer nodes maintain the blockchain and cryptographically validate each new block and thus the transactions contained in the corresponding block. Importantly, the validation process provides a consensus mechanism, which allows for the trustless exchange of value over communications networks, such as the Internet, and makes the history of transactions transparent.

New innovations are continuously being generated in this field, and the invention disclosed herein is one of them.

### SUMMARY OF THE INVENTION

In one aspect, this invention relates to a method for rewarding users of a product with benefits related to the ownership of a Production Entity that sells the product on a blockchain platform. In one embodiment of the present invention, the method includes the steps of allocating on the blockchain platform with respect to the Production Entity, purchase logic including one or more processor-executable instructions, which when executed by at least one node in the blockchain platform, cause the node to:
register users to the blockchain platform;
process sales orders of the product from the users;
qualify the users to determine the eligibility of each user for receiving a user-specific reward;
calculate a number P of the product to be delivered in a predetermined period of time based on the sales orders from the users; and
provide the number P of the product to a Fintech Entity;
allocating on the blockchain platform with respect to the Fintech Entity, rewards logic including one or more processor-executable instructions, which when executed by at least one node in the blockchain platform cause the node to:
allocate a plurality of non-fungible tokens (NFTs) in total number N, each non-fungible token representing a percentage of stock ownership of the Production Entity;
divide the plurality of non-fungible tokens into a first number N1 of NFTs and a second number N2 of NFTs;
allocate, on the blockchain platform, the first number N1 of NFTs into a purchase base wallet and the second number N2 of NFTs into a rewards pool wallet, respectively, and upon receiving the number P of the product from the Production Entity, allocate a number of redeemable tokens corresponding to the number P of the product;
allocating a user-specific number of redeemable tokens to a user based on the number of the product purchased by a user;
allocating a drawing ticket to a user upon a predetermined number of the redeemable tokens;
drawing rewards in a rewards pool to determine users who have winning drawing tickets, according to reward rules; and
executing a transaction on the blockchain platform providing a user-specific reward to a corresponding user wallet for each of the users who have winning drawing tickets, wherein at least one of the rewards has the benefits of stock shares corresponding to the ownership of the Production Entity.

In one embodiment of the present invention, the method further includes the step of allocating, on the blockchain platform, asset management logic including one or more processor-executable instructions, which when executed by at least one node in the blockchain platform cause the node to execute purchase logic.

In one embodiment of the present invention, the method further includes the step of allocating, on the blockchain platform, asset management logic including one or more processor-executable instructions, which when executed by at least one node in the blockchain platform cause the node to execute reward logic.

In one embodiment of the present invention, the step of registering comprises: allowing a user to open an account; requesting the user to provide user-specific health report from an medical professional service provider that includes personal health parameters measured and collected from the user related to the user's body tissues such as skin, organs, muscles, nerves, blood, etc.; and periodically requesting the user to provide up-to-date user-specific health report from an medical professional service provider that includes personal health parameters measured and collected from the user related to the user's body tissues such as skin, organs, muscles, nerves, blood, etc. to keep the account in good standing.

In one embodiment of the present invention, the step of processing sales orders comprises: allowing a user who has an account to put a purchase order with a specific amount of the product through the blockchain platform; completing the transaction corresponding to the purchase order with payment from the user using fiat or crypto currencies through the blockchain platform; issuing a receipt for the purchase order to the user wallet after the payment from the user using fiat or crypto currencies is deposited into a purchase base wallet from the user wallet; and storing a corresponding smart contract in a decentralized ledger.

In one embodiment of the present invention, the step of qualifying comprises: comparing the number of the products purchased by a user against a predetermined numerical threshold to determine whether the user is qualified to receive a user-specific reward, wherein only when the number of the products purchased by a user is equal or greater than the predetermined numerical threshold, a user is qualified to receive a user-specific reward.

In one embodiment of the present invention, the product is bottled water, and the predetermined numerical threshold equals to a number of the bottled waters to be consumed by a user in a predetermined period of time.

In one embodiment of the present invention, the step of allocating a user-specific number of redeemable tokens comprises: allocating a user-specific number of redeemable tokens to a qualified user equals to the number of the products purchased by the qualified user, wherein the amount of the redeemable tokens that a qualified user can receive in a predetermined time period from the blockchain platform is unlimited.

In one embodiment of the present invention, the step of allocating a drawing ticket to a user upon a predetermined number of the redeemable tokens comprises: receiving a request from the user to redeem a user-specific number of redeemable tokens; dividing the user-specific number of redeemable tokens of a user by the predetermined number of the redeemable tokens to generate an integer I; comparing the integer I against a predetermined limit integer M; allocating I drawing tickets to the user if I≤M; and allocating M drawing tickets to the user if I>M.

In one embodiment of the present invention, wherein once a user redeems a user-specific number of redeemable tokens, the redeemed tokens are collected and then destroyed in rewards pool wallet.

In one embodiment of the present invention, wherein the reward rules for the drawing are predetermined or voted by eligible participants of that drawing.

In one embodiment of the present invention, wherein the drawing is conducted periodically.

In one embodiment of the present invention, wherein the first number N1 of NFTs and the second number N2 of NFTs satisfy the following conditions:

N1+N2=N, and N1<N2.

In one embodiment of the present invention, the method further includes the step of:
auctioning the first number N1 of NFTs;
depositing proceeds from the auctioning to the purchase base wallet; and
storing transaction for each NFT auctioned on a decentralized ledger.

In one embodiment of the present invention, the method further includes the step of:
issuing by the Production Entity, at the beginning of a first predetermined time period tᵢ, time Tₒ, a number N_{cs} of convertible preference shares to a plurality of investing entities, wherein the N_{cs} convertible shares are convertible to N_{cs} ordinary shares of the Production Entity investing entities over a period of time T counting from time Tₒ, calculating the number N_{cs} according to the following formula:

N_{cs}=(PAE×L)/SPₒ,
wherein the ordinary shares of the Production Entity are publicly traded in a capital market, the period of time T is divided into a predetermined number L of the first predetermined time period tᵢ such that T=L×tᵢ, PAE is the projected annual after-tax earning that the Production Entity would make from the sales of the product as well as auctioning the first number N1 of NFTs over the period of time T, and SPₒ is the stock price per share for the ordinary shares of the Production Entity averaged over a second predetermined time period t₂ around time Tₒ;
receiving cash or cash equivalents payments by the Production Entity from the plurality of investing entities, wherein the cash or cash equivalents payment are made by the investing entities for the convertible shares, respectively;
aggregating in every first predetermined time period ti over the period of time T by the platform all the cash or cash equivalents payments received from the investing entities into a first amount, {M₁ᵢ, i=1, . . . , L};
calculating Eᵢ, the after-tax earning that the investing entities would make from the cash or cash equivalents payments investing in capital markets over the ith first predetermined time period t₁;
when cash or cash equivalents payments are made by the Production Entity to the plurality of investing entities, aggregating all the cash or cash equivalents made in a second amount, {M₂ᵢ, i=1, . . . L}, in every first predetermined time period tᵢ over the period of time T, wherein M₁ᵢ and M₂ᵢ satisfy the following relationships:

M₂ᵢ<M₁ᵢ, and

(M₁ᵢ−M₂ᵢ)×(1−Rtax)=Eᵢ;
making book entries by at least one node on the platform for all the cash or cash equivalents payments received and storing corresponding records of the book entries in the decentralized ledger;
calculating a maximum number Nᵣₛ, which is determined by the following formula:

Nᵣₛ=Σ^{L}ᵢ₌₁N_{cs}(i)×αᵢ
where {αᵢ} satisfy the condition of Σ^{L}ᵢ₌₁αᵢ<1, and the number of N_{cs} convertible preference shares issued to the plurality of investing entities converted to a number of ordinary shares of the Production Entity over the period of time T is no greater than the maximum number Nᵣₛ; and
when a number of ordinary shares of the Production Entity is delivered to the investing entities, making book entries by at least one node on the blockchain platform for the delivered ordinary shares of the Production Entity and storing corresponding records of the book entries in the decentralized ledger.

In one embodiment of the present invention, the method further includes the step of instead of receiving a number of ordinary shares of the Production Entity by the investing entities: allocating a plurality of a second class of non-fungible tokens (NFTs) in total number X, each non-fungible token representing a percentage of stock ownership of the Production Entity in the form of convertible preference shares; and allocating, on the blockchain platform, a number of the second class NFTs into an investing entity specific wallet for each of the investing entities, respectively, in lieu of the cash or cash equivalents payments.

In one embodiment of the present invention, wherein the blockchain platform includes a plurality of nodes that are coupled to one another via a communications network, each node including a processor operatively coupled to a memory and configured to execute at least one of the purchase logic and the rewards logic.

In yet another aspect, this invention relates to a method rewarding users with ownership of a company in a form of stocks. In one embodiment of the present invention, the method comprises the steps of issuing, by an asset management unit, a number of fungible tokens according to a number of products related to the company in a predetermined period of time provided by the company; distributing the fungible tokens into wallets of users who purchase one of the products of the company from a blockchain platform; issuing drawing tickets to the wallets of the users who redeem the fungible tokens, wherein the drawing tickets are automatically entered into a rewards pool for drawing; drawing rewards in the rewards pool to determine winners from the users who have the drawing tickets, according to reward rules; and issuing the rewards using smart contracts and depositing the rewards into wallets of the winners, wherein the winners redeem the rewards by claiming the drawing tickets in their wallets.

In one embodiment of the present invention, the method further comprises the step of creating a limited series of non-fungible tokens (NFTs) including a first number of NFTs and a second number of NFTs, wherein each of the first number of NFTs and the second number of NFTs is associated with a percentage of the ownership of the company in the form of stocks and includes a subscription of the product for a predetermined period of time.

In one embodiment of the present invention, the first number of NFTs are available for sale by auction, and the second number of NFTs are not available for sale and only available as rewards through participation in the rewards pool.

In one embodiment of the present invention, the second number of NFTs are stored in the rewards pool.

In one embodiment of the present invention, said distributing the fungible tokens comprises redeeming, by the users, a proper amount of the fungible tokens to receive at least one drawing ticket to participate in the rewards pool draw for receiving one of the second number of NFTs if winning.

In one embodiment of the present invention, said distributing the fungible tokens comprises: purchasing, by the user, a predetermined number of the products with fiat or crypto currencies through the blockchain platform, wherein the blockchain platform receives the fiat or crypto currencies and deposits the fungible tokens into the wallets of the users.

In one embodiment of the present invention, the amount of the fungible tokens that each user is capable of having through buying the products per month on the blockchain platform is unlimited, while each user is only permitted to redeem a predetermined number of the fungible tokens per month.

In one embodiment of the present invention, the reward rules for the drawing in each month are predetermined or voted by eligible participants of that month.

In one embodiment of the present invention, once a user redeems a number of the fungible tokens, the asset management unit collects the redeemed tokens and destroys them.

In one embodiment of the present invention, the smart contracts are stored on a decentralized ledger.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows a system according to one embodiment of the present invention;

FIG. 2 is a system according to one embodiment of the present invention related to FIG. 1;

FIG. 3 is a system according to aspects of the disclosure;

FIG. 4 a diagram of an example of a computing device, according to aspects of the disclosure;

FIG. 5 a diagram of an example of a pool contract that is allocated on the blockchain platform of FIG. 3;

FIG. 6 is a diagram of an example of an asset management contract that is allocated on the blockchain platform of FIG. 3, according to aspects of the disclosure;

FIG. 7 is a flowchart of an example of a process, according to aspects of the disclosure;

FIG. 8 is a diagram of another example of an asset management contract that is allocated on the blockchain platform of FIG. 3, according to aspects of the disclosure; and

FIG. 9 is a flowchart of an example of a process, according to aspects of the disclosure.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, the phrase at least one of A, B, and C should be construed to mean a logical (A or B or C), using a non-exclusive logical OR. As used herein, the term “and/or” includes any and all combinations of one or more of the associated listed items.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

As used herein, the terms chip or computer chip generally refers to a hardware electronic component, and may refer to or include a small electronic circuit unit, also known as an integrated circuit (IC), or a combination of electronic circuits or ICs.

As used herein, the term microcontroller unit or its acronym MCU generally refers to a small computer on a single IC chip that can carry out instructions of computer programs by performing basic arithmetic, logical, control and input/output (I/O) operations specified by the instructions for controlling other devices or machines. A microcontroller unit contains one or more central processing unit including one or more processors along with memory and programmable I/O peripherals, and is usually designed for embedded applications.

As used herein, the term system on a chip or its acronym SoC generally refers to an integrated circuit that integrates all or most components of a computer or other electronic system. These components include, but are not limited to, a central processing unit, memory, hard-disk and USB connectivity, secondary storage, input/output ports, and/or their controllers, often alongside other components such as sensing/detecting modules, power modules, and wireless modules (e.g., Wi-Fi and cellular network radio modems) on a single substrate or microchip. It may contain digital, analog, and mixed-signal processing functions.

The term interface, as used herein, generally refers to a communication tool or means at a point of interaction between components for performing wired or wireless data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms computing node or node, as used herein, generally refer to a basic unit of computer systems. A node may be implemented by a physical device or a virtual device. For example, a computing device such as a personal computer, a laptop computer, a tablet or a mobile device may function as a node. A peripheral device such as a printer, a scanner or a system on chip (SoC) may also function as a node. A virtual device, such as a virtual machine (VM), may also function as a node. When defining nodes on the Internet, a node refers to a device or a data point having an IP address.

The term code, as used herein, may include software, firmware, and/or microcode, and may refer to programs, routines, functions, classes, and/or objects. Some or all code from multiple modules may be executed using a single (shared) processor. In addition, some or all code from multiple modules may be stored by a single (shared) memory. Further, some or all code from a single module may be executed using a group of processors. Moreover, some or all code from a single module may be stored using a group of memories.

The devices and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

It will be understood that any of the steps in processes described below may be performed concurrently with other steps in those processes and altogether omitted. It will be further understood that the provision of the examples described herein, as well as clauses prefaced with “such as,” “e.g.”, “including”, “in some aspects,” “in some implementations,” and the like should not be interpreted as limiting the disclosed subject matter to the specific examples.

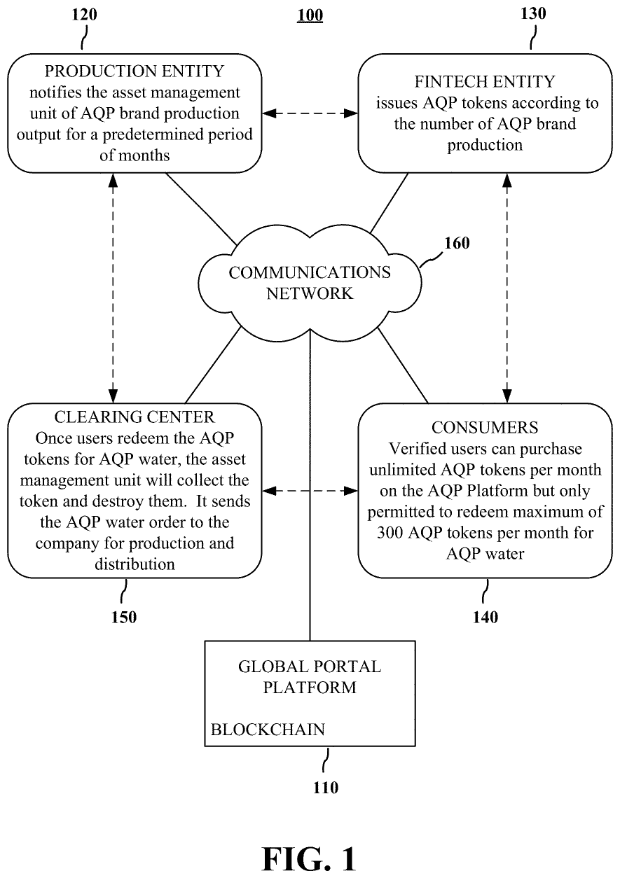

Embodiments of the invention are illustrated in detail hereinafter with reference to accompanying drawings FIGS. 1-9. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

### OVERVIEW OF THE INVENTION

According to aspects of the present invention, an innovative global portal platform that utilizes Distributed Ledger Technology (DLT), commonly known as blockchain technology, to disrupt a consumable product landscape is disclosed, which is a trustless, decentralized system that enables users to purchase the consumable product at desired amount, do social good by contributing the consumable product to a charitable entity, and earn an opportunity to participate in the wealth and asset allocation generated in relation to the production of the consumable product.

In one aspect, the consumable product is a kind of water in a container such as a bottle. And the innovative global portal platform or platform 110 relates to a water ecosystem 100 that is created to disrupt traditional marketing landscape of global high-quality and high-utility bottled water market. The ecosystem 100 includes two main components: a production & logistics component (or “Production Entity 120”) and a fintech component (or “Fintech Entity 130”) where blockchain technology is employed to create process efficiency and enterprise value. The Fintech Entity 130 is adapted for providing a unique token-based payment and NFT issuance system that not only supports the daily operation of the Production Entity 120, but also creates wealth through its unique “fivefold growth model”, which can be enjoyed by and awarded to users or consumers 140, and then shares the resulting benefits through the ecosystem's charitable entity (under the Fintech Entity 130) to population who otherwise cannot economically afford the product. With exponential accumulation of the profits created by this unique structure, the NFTs may appreciate in value mirroring the financial success of the Production Entity 120, which may be listed in the stock markets as a public company and then the financial success of the Production Entity 120 may be measured by the stock performance of the Production Entity 120; at the same time, since the ecosystem 100 is expected to create a steady stream of cash flow in US dollars similar to a monetary peg system, it may be used as the source to create a stablecoin in trade and investment activities globally, which is further disclosed infra.

In one particular example, AQP water is utilized to produce bottled water to be consumed by users of the ecosystem 100. AQP is a special term derived from aquaporins, also called water channels. Aquaporins are channel proteins that facilitate transport of water molecules between cells. Aquaporins were discovered by Professor Peter Agre of Johns Hopkins University in the United States, whose work on the subject won the 2003 Nobel Prize in Chemistry. As used herein, AQP water may be considered as a source of next generation of drinking water because it may have certain health benefits.

According to a study conducted by Wen, Jing, Ph.D. (Jan. 17, 2022), The Effects of AQP Active Water on Preservation of Telomere, David Geffen School of Medicine at UCLA, AIDS Institute UCLA, the entirety of which is incorporated herein by reference, cells cultured in AQP water after 10, 15 and up to 20 passages show a 56%, 76%, and 105% increase in their telomere length in comparison with the cells cultured in the control water, respectively. A telomere is the end of a chromosome. Telomeres are made of repetitive sequences of non-coding DNA that protect the chromosome from damage. Each time a cell divides, the telomeres becomes shorter. Eventually the telomeres becomes so short that the cell can no longer divide, or causing the cells to “age”. Therefore, telomeres act as the aging clock in every cell. Based on the UCLA study mentioned above, consistent consumption of AQP water may potentially lengthen telomeres, effectively slowing down the aging process.

While modern research has discovered that telomeres perhaps are the code for longevity in the human body, science has also identified cellular inflammation and oxidative stress as the root cause of various diseases. The same study mentioned above on preservation of telomere also tested the effect of AQP water on genes that are relevant to inflammation and oxidative stress. Compared to cells cultured in the control water, culturing cells with AQP water in 27 passages suppressed the NF-kB (a mediator of pro-inflammatory gene and an indicator for inflammation) gene expression for ˜5 folds, indicating an anti-inflammation effect of AQP water. Nrf2, a major indicator of oxidative stress, was 0.5-fold lower for cells cultured in AQP water then the control water. Keap1, an inhibitor of Nrf2, was 0.7-fold higher for the cells cultured in AQP water than control water. This result suggests that AQP water can effectively release oxidative stress of the cells. Accordingly, AQP water is a great candidate for the next generation of drinking water catering to the entire human race.

In one aspect, Production Entity 120 is adapted to produce bottled AQP water for mass consumption by partnering with OEMs worldwide. Instead of relying on either the traditional wholesale to retail or HOD (home or office delivery) business model, Production Entity 120 is utilizing blockchain technology throughout the AQP ecosystem 100 to manage AQP water's entire life cycle, making the process a lot more efficient and cost-effective.

Furthermore, Fintech Entity 130 is adapted to process all of the customer orders and payments, so Production Entity 120 may focus on production management, supply-chain logistics and distribution. AQP water may be only available by purchasing and redeeming AQP tokens on the AQP Platform 110, managed and operated by Fintech Entity 130.

Production Entity 120 may be owned in part by Fintech Entity 130. Production Entity 120 and Fintech Entity 130 may cooperate to issue a limited series of AQP NFTs that may be linked to the ownership of Production Entity 120 by Fintech Entity 130 through publicly tradable shares. AQP NFTs can be auctioned, and traded in the market place. Proceeds from the AQP NFT sales (less fees & expenses) may be used for Production Entity 120 in a range of business activities including expansion of AQP water production capacity, and related research and development activities.

In one particular example, AQP tokens are ERC-20 utility tokens issued by Fintech Entity 130 to be used to redeem AQP water on the AQP Platform 110. Each AQP token may be redeemed for a bottle of AQP water, say 400 ml or another proper size. Each AQP token is priced at a given value worldwide, say US$3.00 for a 400 ml bottle. Each month, based on the production capacity of Production Entity 120, Production Entity 120 informs Fintech Entity 130 the number of bottles of AQP water Production Entity 120 can deliver in a later given time, say 6 months or another predetermined time. Fintech Entity 130 then issues the same number of AQP tokens for sale on the AQP Platform 110 for that month available for delivery in the later given time, say 6 months.

Since health experts have commonly recommended drinking 2 liters of water daily or 5 (five) 400 ml of bottled water, or 150 bottles per month, the minimum number of AQP tokens for redemption each month by a user is 150 so users may enjoy maximum health benefits AQP water provides in a month.

In one aspect, to encourage users to drink 150 bottles of AQP water each month, for each 150 AQP tokens redeemed by a user 140, the user 140 receives a ticket which will be automatically entered into that month's AQP Award Pool for award drawings. In one example, awards include tradable stocks up to a certain amount of, say 8%, ownership stake in Production Entity 120, AQP tokens, cash and cash equivalent (such as USDT and DAI), plus other ‘grab bag’ items. The cash and cash equivalent portion of the AQP Reward Pool may be entirely contributed by Production Entity 120 utilizing its profit associated with the sale of AQP tokens and AQP NFTs.

Furthermore, for those consumers who not only are interested in the health benefit of AQP water but also are interested in the value creation AQP water brings to Production Entity 120, Fintech Entity 130 may create a limited series of non-fungible tokens (NFTs) linked to its ownership in Production Entity 120 as well as a committed subscription of 1,825 AQP tokens per annum, where a committed subscription may be for a lifetime or for a predetermined period of time, say 10 years. These users with committed subscription of AQP tokens become owners of the AQP NFT Series as the most valuable members of the AQP community who deservedly would share the most wealth creation alongside with Production Entity 120 as well as Fintech Entity 130.

In one aspect, Fintech Entity 130 may issue a series of a number of NFTs, for example 100,000 NFTs, where each NFT is entitled to a corresponding number of tradable shares of Production Entity 120, for example 10,000 Class B Production Entity 120 shares, which in turn corresponds to a certain percentage of Production Entity 120 ownership stake by Fintech Entity 130. In the example where 100,000 NFTs are issued, these 100,000 NFTs correspond to 10% of Production Entity 120 ownership stake by Fintech Entity 130. These 100,000 NFTs may be divided into a first set and a second set. The first set of NFTs may be allocated for auction at a first price to users 140, and the second set of NFTs may be allocated to the AQP Reward Pool to be rewarded to users 140 according to certain rules and conditions that can be programmed and executed by a controller. In one example, the first set of NFTS has 20,000 NFTs, which may be named as the Diamond Series, each of them may be auctioned at a predetermined floor price. In one example, the predetermined floor price is set at $10,000. Proceeds of the auction sale of the first set of NFTs, or the Diamond Series, after deducting management fees and costs, say 10%, may be used by Production Entity 120 to expand its AQP water production capacity. The second set of NFTs contains remaining 80,000 NFTs, which may be named as the Platinum Series. The second set of NFTs are not for sale, but as rewards stored in the AQP Reward Pool. In other words, the only options to own AQP NFTs are either through purchasing one of the limited 20,000 units of Diamond Series NFTs or by redeeming packages of 150 AQP tokens to enter the monthly AQP Reward Pool drawings for one of the 80,000 units of Platinum Series NFTs. It is noted that each NFT corresponds to a committed subscription of 1,825 tokens per annum, which may be redeemable quarterly.

In one aspect, the AQP Reward Pool is created by Fintech Entity 130 through Platform 110 to encourage consumers 140 or AQP community members to consume the recommended 2 liters or 5 (five) 400 ml bottles of AQP water daily, or 150 bottles monthly. For every 150 AQP tokens redeemed by a user for AQP water, the user automatically receives a ticket, through the user's account associated with the Platform 110, from Reward Pool wallet into a corresponding user wallet, which may be entered into that month's AQP Reward Pool for reward drawings. All rewards can be either profit generated from the sale of the AQP tokens as well as tradable stock shares corresponding to ownership stake in Production Entity 120 by Fintech Entity 130 in the form of AQP Platinum Series NFTs.

In one aspect, the ecosystem 100 has a first Reward Pool related to the first set of NFTs, and a second Reward Pool related to the second set of NFTs, where the first Reward Pool and the second Reward Pool may be set up separately, or may be set up in one Reward Pool with different rules. In one example, the first Reward Pool is the Diamond Reward Pool, and the second Reward Pool is the Platinum Reward Pool, which may be formed as the AQP Reward Pool. For each of the Platinum Reward Pool participants who redeems 150 AQP tokens for AQP water, the user each time will automatically receive a ticket to participate in the AQP reward pool drawings every month. The rewards include:

All dividends Fintech Entity receives from its 10% ownership stake in Production Entity (less ˜9% management fee) are contributed toward AQP Reward Pool for reward drawings; and

The 8% ownership stake profit in Production Entity in the form of AQP Platinum Series NFTs, in the form of 80,000 units of Platinum Series NFTs. Each NFT is entitled to 10,000 Class [B] Production Entity shares, plus [lifetime] subscription of 1825 AQP tokens per annum, redeemable quarterly.

For each of the Diamond Reward Pool participants who owns the Diamond Series NFTs, the user will automatically receive a ticket every month to participate in the reward drawing exclusively for Diamond Series users. The rewards include:

1,000 Platinum Series NFT units in total. Before AQP water is ready for delivery, 120 NFTs will be available as reward prizes each month; and

54% (60% less 10% fee to Fintech Entity) of the sale profits from all Diamond Series NFT auctions that exceed the reserve price ($10,000) will be contributed to reward pool, which will be drawn once APQ water begins delivery.

In another aspect, the ecosystem 100 is adapted to utilize inventive systems and methods disclosed in U.S. Pat. Nos. 7,716,087, 7,647,464, 8,341,027, 8,473,359, 9,837,818, which were issued to Dr. Benjamin Yeung, the disclosure of each of these patents is incorporated herein by reference in its entirety. Using the ecosystem 100 to practice the present invention not only re-distributes wealth and optimally utilize resources such as AQP water, but also creates additional wealth simultaneously. According to “Pareto Principle” (aka 80/20 principle), 80% of world's wealth is controlled by 20% of world's population. Similarly, it is reasonable to expect 20% of Production Entity 120 potential customers may be able to contribute 80% of profit. In other words, it may imply one user or customer of AQP water with sufficient purchasing power may be able to subsidize 5 other people who otherwise may be financially challenged to purchase.

In one example, the ecosystem has incorporated blockchain technology through a global portal platform resulting in a more efficient and lower-cost system: for every $3.00 spent on an AQP token redeemable for one bottle of AQP water, it can produce a total of six bottles of AQP water while still leaving Production Entity 120 with a profit of $1.10 per token. Therefore, the AQP ecosystem 100 is designed such that for every bottle of AQP water sold, five more bottles may be donated to charity to be distributed for free. As for Fintech Entity 130, for every AQP token purchased, Fintech Entity 130 will create five Charity tokens, redeemable for AQP water at a predetermined time, for example 12 months, after they are minted. Charity tokens may be distributed by a charitable entity associated with Fintech Entity 130.

As set forth above, Charity tokens may be used to share the benefit of AQP water with more people who otherwise may not afford it. Furthermore, utilization of Charity tokens generates more demands for AQP water produced by Production Entity 120, thereby stimulating the growth of Production Entity 120, which in turn constitutes the “fivefold growth model” (where 1 AQP token creates 5 Charity tokens). Accordingly, one paying customers with high purchasing power buys APQ water and subsidize 5 (five) times more “charity customers” who otherwise cannot afford the product. This effectively grows the demand base by 5 (five) folds automatically, which facilitates Production Entity 120 to team up with production partners.

In one aspect, with respect to the AQP ecosystem 100, production serves as a vital link between Production Entity 120 and Fintech Entity 130. The number of AQP tokens sold in a particular month is based on AQP water production capacity in a predetermined later time, for example, in 6 months. That same month, Production Entity 120 thus would know exactly how many bottles it may need to deliver in the predetermined later time, here in 6 months, because it is the number of AQP tokens redeemed that month. The higher production capacity the OEM has due to increased demand from Charity tokens, the more AQP tokens can then be sold, which results in more profit. More profit means the AQP Reward Pool size increases, incentivizing users to participate in drawings by purchasing more AQP tokens and then redeem them. As more AQP tokens are purchased, more profits are generated, so are more Charity tokens. More production capacity is ensured, more AQP tokens can then be sold, the cycle continues to repeat itself. Each step within the sequence of the entire AQP water product lifecycle keeps in lockstep with the next, which is only made possible because of the adoption of blockchain technology.

In one example of practicing the present invention, after the 100,000 AQP NFTs have been sold, it is expected there are 600 production lines capable of operation, among which 100 production lines for paying customers, and 500 production lines for charity. The number of production lines that will come online is based on AQP water demand, which will be managed by Production Entity 120. The 100 profit-generating production lines will be allocated strategically worldwide in markets where AQP token sale is most concentrated for maximum logistics efficiency.

Since each paying user is expected to consume 5 bottles of AQP water daily or 1825 bottles annually, each user's annual profit contribution to Production Entity 120 is $1.10×1,825=$2,007.50 or approximately $2,000.

Each production line may be adapted to support an estimated 100,000 users or “paying customers”, i.e., those who redeem AQP tokens and not charity tokens. Therefore, once full capacity (total of 100 profit-generating production lines) has been reached, the estimated profit is $2,000 per user*100,000 users/production line*100 production lines=$20,000,000,000 or $20 billion (before deducting management fees and costs to Fintech Entity 130).

Since the AQP NFT Series (100,000 units in total) represents 10% equity stake in Production Entity 120, each AQP NFT's share of the estimated profit after Production Entity 120 to Fintech Entity 130's 10% management fee is $18,000 when Production Entity 120 reaches 100 paying production lines, $20 billion in total profit.

Capital markets currently pays below 1% dividend yield on average. Assuming an 1% dividend yield, the implied value for each AQP NFT is $1,800,000.

In addition, since each AQP NFT includes 10,000 tradable stock shares of Production Entity 120 and a subscription of 1,825 AQP token per year for a predetermined time period upto life time, it implies each NFT receives equivalent of $5,475 of current income annually. Applying average capital market rate of 1%, the implied value of the NFT is $547,500 using discounted cash flow analysis.

In one aspect, given the AQP ecosystem is estimated to generate approximately US$20 billion in profit annually backed by an unlimited supply of a natural resource: water, once the ecosystem 100 is fully in operation and reaches full capacity, when applying estimated dividend cash flow as the projected annual earning defined in the financial patents by Dr. Benjamin Yeung as set forth above, the resulting cash reserve has the characteristics of a currency peg system, similar to Hong Kong's monetary regime.

Accordingly, a stablecoin, similar to Tether (USDT) with a market valuation of $84 billion, may be developed from this cash reserve. This stablecoin, being backed by reserves in US dollars, once both internal and external conditions are met, could be used to facilitate cross-border trade and investment activities of stakeholders of, as well as users within the AQP ecosystem. In the future, with more and more stakeholders using this stablecoin in their business activities, it could also become a de facto currency pegged to US dollar, potentially being adopted by sovereign state/states as the legal tender.

Given the AQP ecosystem is estimated to generate minimum of US$20 billion in profit annually backed by an unlimited supply of a natural resource: water, when applying this cash flow to the patented “Summation of Infinite Second Order Differential Equations”, the resulting cash reserve has the characteristics of a currency peg system, similar to Hong Kong's monetary regime.

### AN EXEMPLARY PRACTICE OF THE INVENTION

According to aspects of the present invention, an exemplary embodiment is further described below.

1. AQP Platform

Asset Management LLC (“Fintech Entity”) is launching the AQP Platform which is a combination of the AQP app and the AQP website at www.AQP.io. The AQP Platform is a single platform with a suite of services serving the AQP community where consumers globally can order premium drinking water enhanced with scientifically proven health benefits delivered to their doorsteps by redeeming AQP tokens. In the process, consumers can also participate in all the opportunities the new crypto economy has to offer.

2. AQP Tokens

AQP token is the utility token used throughout the AQP ecosystem as the basis of all transactions. It is an ERC-20 utility token built on the Ethereum blockchain. Its primary value is to redeem for AQP water on the AQP Platform either on the AQP app or the AQP website. Additionally, once a certain minimum number of AQP tokens have been redeemed by a verified user in one month, that user automatically qualifies to participate in the APQ Reward Pool where certain rewards (which can also be APQ tokens, among other rewards) are distributed at the end of each month. (See Section: AQP Reward Pool)

Each AQP token is entitled to 1 (one) 400 ml bottle of AQP Water.

Each AQP token is priced at US$3.00.

2.1 AQP Token Mining and Minting Process

Before consumers can order AQP water, they must first download the AQP app or visit the AQP website at www.AQP.io. AQP water is ordered by redeeming AQP tokens on the APQ Platform. Initially, AQP tokens are only available for purchase on the AQP Platform. An exchange named as Tau[coin] Exchange is under development where users will be able to buy and sell AQP tokens for fiat and cryptocurrency.

Once consumers have registered on the AQP Platform and created an account, they become users of the AQP Platform where they can then purchase AQP tokens. On the 1^{st} day of each month, based on its production capacity, Production Entity informs Fintech Entity the number of bottles of AQP water it plans to distribute in [1/3/6] month(s). On the same day, Fintech Entity releases the exact number of AQP tokens on the APQ Platform for users to purchase for delivery in [1/3/6] months. AQP tokens purchased will be stored in the user's wallet managed by Fintech Entity. There is no upper limit on how many AQP tokens each user can purchase each month, but the minimum number is 150. Health experts have commonly recommended drinking at least 2 liters of water per day or 5 (five) 400 ml bottles, which equates to 150 bottles per person each month. In order to encourage users who have purchased AQP tokens to redeem them for AQP water for its health benefits as opposed to trading the AQP tokens for profit on the upcoming Tau[coin] Exchange, users who redeem a certain minimum number of AQP tokens each month will be automatically entered into the AQP Reward Pool for award drawings, where majority of the rewards represent (some significantly) higher upside potential then trading profits. [See Section: AQP Reward Pool]

Once the users have placed their AQP water orders on the AQP Platform by redeeming their AQP tokens, Fintech Entity will collect those tokens from the users' wallet and burn them from inventory, thereby taking them out of circulation. The AQP water orders will be processed and forwarded by [Clearing Center] to Production Entity, whose logistics division will manage the AQP water distribution process to the users' addresses.

2.2 AQP Token Utility

Each AQP token will be used to purchase 1 (one) 400 ml bottle of AQP water produced by Production Entity.

2.3 AQP Token Specification

| | |
|---|---|
| Token Name | AQP Water Token |
| Token Code | AQP |
| Token Sale Price | USD 3.00 |
| Issuance Standard | ERC-20 |
| Initial Issuance Amount | [18,000,000] |
| Use of Proceeds | Section 5.1 |

3.4 AQP Token Initial Coin Offering (ICO)

The Initial Coin Offering (ICO), or the sale of the initial batch of [18,000,000] AQP tokens, redeemable for AQP water for delivery starting at a predetermined time.

Each AQP token is priced at US$3.00.

All of the token sales will take place on the AQP Platform. Buyers must first register on either the AQP app or the AQP website and create a user account, then follow the instruction on the screen to complete the purchase.

All annual subscriptions to AQP tokens will include annual health tests, one to be tested prior to drinking AQP water, one to be tested after every 12 months of AQP water consumption and on annual basis thereafter.

Until AQP water is available for delivery (the “AQP Token Presale”), Fintech Entity has incorporated additional rewards to compensate users. For every 3,000 users who have redeemed packages of 150 AQP tokens to pre-order AQP water, Fintech Entity will pre-release a Series B (Reward Series) NFT to the AQP Reward Pool as rewards. In other words, the odds for winning a Series B (Reward Series) NFT is 1/3,000. It is currently estimated that AQP water will be ready for delivery within [6] months of the ICO.

Fintech Entity's AQP token offering is independent of Production Entity's global manufacturing locations or distribution capabilities. Production Entity is responsible for AQP water distribution.

3. AQP NFT Series

4.1 History Behind the Creation of the AQP NFTs

“Winning through innovation”: On one hand, Fintech Entity aims to disrupt the global premium bottled water market by creating a unique app-based all-in-one home delivery system incorporating the most advanced blockchain technology and digital payment options catering to the health-conscience society at large after the onset of Covid-19 pandemic. On the other hand, it is setting out to disrupt the global capital markets.

The regulated capital market has never been a level playing field. Double-digit, private-equity type returns are not often available to the average retail investors. However, the advent of blockchain technology and its decentralized nature has revolutionized financial markets globally, providing the investing public a new option by way of cryptocurrencies, altcoins and more recently, non-fungible tokens (NFTs).

While digital assets have in times outperformed the rest of the market in the past several years (although some from Wall Street and Washington would argue those high returns are the direct beneficiaries of easy monetary policy and not the result of fintech innovation); equity ownership in corporate America is still one of the best ways to own and create value, especially when taking into consideration of legal protection the US legal system provides. However, there are very few options available for the average retail investors to own equity in a company given the centralized nature of regulated capital markets.

To address this issue, the decentralized world of crypto has attempted to offer its own solutions. First, there are Security Token Offerings (STDs), which are just digitized versions of common stock offerings. Security tokens are therefore investment products regulated by securities laws. Crypto markets then introduced tokenized stocks or stock tokens (such as those traded on FTX or Bittrex Exchanges) which are spot tokens pegged to the value of the relevant share. These tokens are backed by the underly shares of the stock custodied by the Exchange, with the underlying shares held in trust with a licensed broker. In theory, stock tokens can be redeemed for the underlying shares if desired. Stock tokens have indeed become popular because they can trade in fractions; but to date, they are only available for a few popular US stocks such as Apple, Tesla which trade at a high dollar price with enough flow. This product is also only available outside of the US.

At Fintech Entity, it is believed there is a better, more efficient approach to incorporate blockchain technology and equity ownership, resulting in a new tokenized asset that is also higher-yielding then owning shares outright without using any leverage or derivatives.

As Production Entity's largest shareholder, Fintech Entity is creating a limited series of non-fungible tokens (NFTs) of its 10% ownership in Production Entity.

4.2 What are AQP NFTs?

Fintech Entity has pledged 1,000,000,000 shares of Production Entity from its ownership stake in the company (equating to 10% ownership in Production Entity) to create 2 (two) limited series of AQP NFTs: 20,000 units of Series A NFTs and 80,000 units of Series B (the Reward Series) NFTs, totaling 100,000 units. Each NFT represents 10,000 shares of Production Entity, held in trust with Fintech Entity.

The AQP NFT Series are ERC-1155 tokens in one embodiment, the advanced version (then ERC-721) for non-fungible token on the Ethereum platform. This standard allows a smart contract to track token ownership at the individual token level where each item has a unique identifier; ideal for tracking stock ownership as proposed by the AQP NFTs structure.

As an additional reward, owners of both Series A and Series B NFT units also enjoy a lifetime subscription of 1,825 AQP tokens (redeemable quarterly), as well as annual health tests.

For the Production Entity shares held in trust by Fintech Entity under the proposed NFT structure, owners of each AQP NFT are entitled to all rights of Production Entity equity ownership as a Production Entity shareholder who owns the share(s) outright; including but not limited to: annual dividends (if any), (equity) ownership verification issued by Fintech Entity of Production Entity stock certificate held in owner's name, conversion to Production Entity shares upon owner's request.

4.3 AQP NFTs Specifications

| | Series A | Series B |
|---|---|---|
| NFT Series Name | Classics Series | Rewards Series |
| Underlying Asset | 10,000 shares of | 10,000 shares of |
| | Production Entity stock | Production Entity stock |
| Auction Floor Price | US$10,000 | N/A |
| Issuance Standard | ERC-721 | ERC-721 |
| Total Series Units | 20,000 | 80,000 |
| Use of Proceeds | Section 6.5 | Section 7.2 |

4.4 AQP NFTs Sale Process

The AQP NFTs Presale

The sale of the first 3,000 units of Series A (Classics Series) NFTs (the “AQP NFTs Presale”) will commence at a predetermined time.

Each unit of Series A (Classics Series) NFT is priced at US$10,000 (the “Floor Price”). The AQP NFTs Presale will take place on the AQP Platform. Buyers must first register on the AQP Platform and create a user account, then follow the instructions on the screen on how to place their bids.

Until AQP water is available for delivery, Fintech Entity has incorporated additional rewards to compensate the first 3,000 buyers who are our most valuable partners. Fintech Entity will pre-release a total of 1,000 Series B (Reward Series) NFTs allocated only to those who participated in the AQP NFTs Presale, where 120 units will be available for drawings each month, or 720 for 6 (six) months. At the end of the 6 (six) months, the remaining 280 NFT units will all be entered into this special reward pool for drawings. Every person who has ever participated in the AQP NFT Presale is eligible for this special reward pool. It is currently estimated that AQP water will be ready for delivery within [6] months of the AQP NFT Presale.

Ongoing Auctions

Of the remaining 17,000 units of Series A (Classics Series) NFTs, Fintech Entity will hold auctions periodically on the AQP Platform. Fintech Entity plans to auction all remaining Series A (Classics Series) 17,000 NFTs by the end of Year 1.

AQP NFTs Series B: Reward Series

The 80,000 units of Series B (Reward Series) NFTs are not available for sale. They are only available as rewards through participation in the AQP Token Rewards Pool (See Section 7: AQP Token Reward Pool).

5 AQP Token Reward Pool

5.1 AQP Token Reward Pool Overview

Given health experts have commonly recommended drinking at least 2 liters of water per day or 5 (five) 400 ml bottles, which equates to 150 bottles per person each month, Fintech Entity strongly encourages the AQP community to experience maximum health benefit AQP Water can offer by consuming 5 bottles of AQP Water daily. Therefore, Fintech Entity have designed a system to incentivize the AQP community to drink 5 bottles of AQP Water daily (or 150 bottles each month) by rewarding users through the AQP Reward Pool.

Once a user has redeemed a package of 150 AQP tokens for 150 bottles of AQP Water each month, the user is automatically eligible to participate in that month's AQP Token Reward Pool for drawings. Each 150 AQP tokens redeemed qualifies as one ticket (“Ticket”). For example, if the user redeems 300 AQP tokens in a month, the user receives 2 (two) Tickets for that month's drawing. The maximum number of tokens that can be redeemed per month is 300. In other words, the maximum number of Tickets each verified user allowed to enter each month's drawing is 2 (two).

Upon redemption of each package of 150 AQP tokens, Fintech Entity will automatically issue a new Ticket using smart contract stored in the user's wallet.

5.2 What are the Rewards?

Example of rewards are:
80,000 units of AQP Series B (Reward Series) AQP NFTs, equating to 8% of Production Entity ownership
AQP tokens
Stablecoins (such as USDT or DAI)
Cash
Others [such as one-off/collectable NFTs & other “grab bag” NFTs])

All dividends Fintech Entity receives from its 10% ownership stake in Production Entity pledged to AQP NFTs issuance (less 10% management fee) are contributed toward AQP Reward Pool for reward drawings. Production Entity's earnings come from two sources: AQP token sales, and 40% of sale proceeds from AQP NFT Series above the $10,000 Floor Price. Therefore, the amount of cash contribution to the AQP Reward Pool [at any given time] is calculated as follows:

($1.10 profit per AQP token)×(number of AQP tokens sold)×(1-10% management fee)×(Fintech Entity's 10% ownership in Production Entity pledged to AQP NFT issuance)

plus

(sales proceeds from AQP NFT Series A units sold above $10,000)×(1-10% management fee)×(40%)×(Fintech Entity's 10% ownership in Production Entity pledged to AQP NFT issuance)

Odds of Winning a Series B (Reward Series) NFT

For every 1,500,000 AQP tokens redeemed, 1 (one) unit of Series B (Reward Series) NFT will be created for the AQP Rewards Pool. In other words, the odds of winning a Series B (Reward Series) NFT is 1/10,000 (=150/1,500,000).

5.3 Who Decides on the Reward Rules?

To encourage user participation while ensuring a fair and democratic process, all decisions on how the rewards are distributed may be collectively determined by the AQP user community.

At the end of each month, users who are eligible to participate in that month's AQP Rewards Pool will receive a notification from the AQP Platform to inform them of (1) total cash or cash equivalent amount available for drawing in the AQP Reward Pool, (2) number of Series B (Rewards Series) NFTs available for drawing in the AQP Reward Pool (if any), (3) what the choices on rewards distributions are for that month, (4) instructions on how to vote for reward distribution. Fintech Entity will process the votes, announce the results and distribute the rewards accordingly.

5.4 Rewards Redemption Process

Each reward will be issued using smart contract and deposited into the winning user's wallet. The users with winning tickets can claim the rewards by redeeming those tickets also stored in their wallets.

6 Economy

6.1 Tokenomics

Assumptions:
Given Production Entity's unique business model where most of the overhead costs have been eliminated by incorporating blockchain technology, its cost per unit (400 ml bottle) can be kept relatively low.
   As of 2021, North America, Europe and East Asia have a combined GDP of nearly $75 trillion, making up 80% of the world's GDP in nominal terms. In other words, the inequality in the world's GDP distribution implies the world's disproportion in purchasing power is 80% vs 20%. Putting it another way, 1 (one) rich person has the purchasing power to subsidize 5 (five) poor persons (16.7% vs. 83.3%)
   Therefore, in theory, an efficient model should exist where, when priced competitively, a person with purchasing power is willing to spend “X” dollars on a bottle of AQP water where “X” in fact can produce a total of 6 (six) bottles of AQP water, where the buyer keeps his one bottle and donates the other 5 (five) bottles to charity. In certain situations, the portion allocated to the 5 (five) bottles (or 80%) could be tax deductible as charitable contribution.

The AQP Solution:

Fintech Entity has determined that at US$3.00 per token, the AQP ecosystem does indeed become efficient. $3.00 can manufacture total of 6 (six) bottles of AQP water while still leaves Production Entity with $1.1 per bottle of profit. This is a ground-breaking model where for every US$3.00 spent, a total of 6 (six) persons of not only different income levels but races, social backgrounds, religious beliefs, and other equalities can all share a single common resource: water.

For every bottle of AQP token purchased, 5 (five) charity tokens are created and donated to Charity where they can be redeemed for AQP water free of charge starting 12 (twelve) months later. In other words, Production Entity's production (and expected maximum number of delivery) of AQP water in the first month of Year 2 is 6× (=5+1) of the number of AQP tokens sold in the first month of Year 1.

From Production Entity's perspective, it receives proceeds from the sale of the first 3,000 Series A NFTs (3,000*$10,000=$30,000,000, minus 10% fee to Fintech Entity=$27,000,000) to ramp up production line. [Production Entity has raised (US$10M) Series A funding to secure initial production capacity with OEM.] With each subsequent auction of the remaining 17,000 Series A NFTs throughout Year 1, Production Entity will use the proceeds to continue expanding production capacity. Total proceeds from the NFT auctions ($180,000,000) will be used to purchase equipments for production lines such as reactors, filters, filtration systems, etc., where each production line may at least be fitted with 1 reactor and/or filtration system. As more production lines come online, Production Entity can begin the cycle where it informs Fintech Entity it can deliver the following month, where Fintech Entity issues equal amount of AQP tokens available for sale on the AQP Platform for that month.

Once all 600 production lines (100 designated to AQP tokens, 500 for charity) have come online over Year 1 (funded by the sale of the Series A NFTs over the same 12 months period), the system starts run on its own.

Since each paying user is expected to consume 5 bottles of AQP water daily or 1825 bottles annually, each user's annual profit contribution to Production Entity is $1.10×1,825=$2,007.50 or approximately $2,000.

Each production line can support an estimated 10,000 users or “paying customers”, those who redeem AQP tokens and not charity tokens in Year 1. Therefore, estimated profit in Year 1 is $2,000 per user*10,000 users/production line*100 production lines=$20,000,000,000 or $20 billion.

Since AQP NFT Series (100,000 units in total) represents 10% equity stake in Production Entity, each NFT's share of the estimated profit after Fintech Entity's 10% management fee is $18,000. Based on $10,000 initial cost, the return is 1.8× or 180%. Applying stock market P/E (price/earnings ratio) metrics, it implies the AQP NFTs could be valued at $18,000×1.8=$32,400 at the end of Year 1.

6.2 The Stablecoin

Since the AQP water is priced in US dollars worldwide at US$3.00 per bottle, the AQP ecosystem will provide a stable supply of US dollars at a minimum rate of $20 billion each year, backed by an unlimited supply of natural resource: water. Therefore, the AQP ecosystem has the characteristics similar to a currency peg system, similar to Hong Kong's monetary regime.

Fintech Entity may create a stablecoin backed by US Dollars on a 1:1 basis, based on profit contributions beginning with Production Entity, ultimately expanding to other enterprises with similar characteristics (common user base with global reach, low-cost basis, cross-market appeal, etc.). With the application of the patented “Summation of Infinite Second Order Differential Equations” leveraging cashflow contribution from Production Entity, it is estimated that the initial reserves pool could reach US $1 trillion before or by Year 10.

This stablecoin, which may be in the form of NFT being backed by reserves in US dollars, once both internal and external conditions are met, could be used to facilitate cross-border trade and investment activities of stakeholders of, as well as users within the AQP ecosystem. The stablecoin will greatly reduce the transaction cost related to traditional foreign exchange system, increase the system's efficiency, and enhance security and safety of financial assets. In the future, with more and more stakeholders using this stablecoin in their business activities, it will become a de facto currency pegged to US dollar, potentially being adopted by sovereign state/states as the legal tender. For example, ex-Mayor Eric Adams of New York City choose to take his first paycheck in crypto currency instead of USD; and El Salvador becomes the first country to adopt bitcoin as legal tender.

6.3 Layer-2 Blockchain Platform

Included in Fintech Entity's roadmap, after launching Fintech Entity's own Exchange and NFT Market Place, is its own layer-2 blockchain network. Having its own layer-2 blockchain can minimize users' gas fees and improve transaction experiences on any of the platforms.

In terms of the economic benefits having its own public layer-2 blockchain network could provide to the overall ecosystem outlined in this disclosure, given it greatly reduces transaction costs, more enterprises can adapt the business model alongside Production Entity and be brought “on-chain”, thus more cash flow denominated in US dollars can therefore contribute to the proposed stablecoin system.

### FURTHER DISCLOSURE OF THE INVENTION

According to aspects of the present invention, further disclosures are made below. As already discussed in some detail, although the examples provided throughout the disclosure relate to bottled water as an exemplary product, it will be understood that the present invention may be practiced for any real-world products desired by consumers. In this regard, it will be understood that the concepts and ideas expressed throughout the disclosure can be applied to any suitable context in which the users of a consumable product can participate in a corresponding ecosystem to enjoy the consumable product as well as the rewards from the economic successes related to the consumable product.

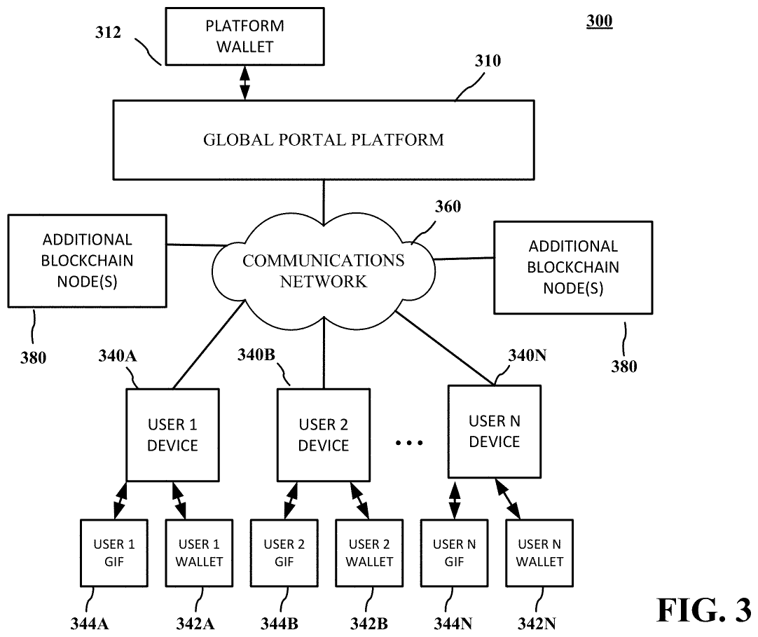

FIG. 3 is a diagram of an example of a system 300, according to aspects of the disclosure. The system 300 includes a plurality of user or client devices 340, a plurality of computing devices or blockchain nodes 380, and a global portal platform 310 that are operatively coupled to one another via a communications network 360. The communication network 360 may include a local area network (LAN), a wide area network (WAN), the Internet, and/or any other suitable type of network. Any of the user or client devices 340 may include any suitable type of a computing device, such as a smartphone, a laptop computer, a desktop computer, a game console, a tablet, and/or any other suitable type of computing device. Any of the computing devices may be a desktop computer, a smartphone, a laptop computer, a server, a distributed computing system, and/or any other suitable type of computing device. Each of the user or client devices 340 may include an interface such as GIF 344, which may be in the form of an APP installed on the user device 340 to allow the user to interact with the platform 310 via network 360, and a user-specific wallet 342 for the user. The platform 310 may include a server, a desktop computer, a laptop computer, and/or any other suitable type of computing device. Although in the present example, the platform 310 is depicted as a monolithic block, it will be understood that in some implementations the platform 310 may include a plurality of computing devices that are coupled to one another via the communications network 310 and/or one or more other networks. In one embodiment, the platform 310 has a platform wallet 312.

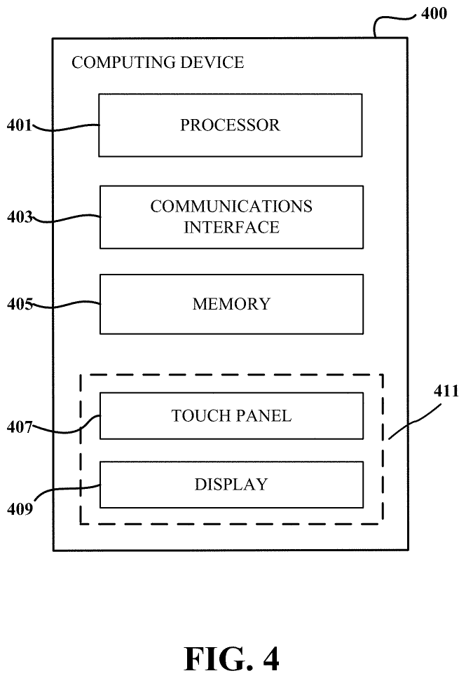

FIG. 4 is a diagram of an example of a computing device 400, according to aspects of the disclosure. As illustrated, the computing device 400 may include a processor 401, a communications interface 403, a memory 405, a touch panel 407, and a display 409. According to aspects of the disclosure, the processor 401 may include any suitable type of processing circuitry, such as a general-purpose processor (e.g., an ARM-based processor), an application-specific integrated circuit (ASIC), or a Field-Programmable Gate Array (FPGA). The communications interface 403 may include any suitable type of communications interface, such as a Wi-Fi interface, an Ethernet interface, a Long-Term Evolution (LTE) interface, a Bluetooth Interface, an Infrared interface, etc. The memory 405 may include any suitable type of volatile and non-volatile memory, such as random-access memory (RAM), read-only memory (ROM), flash memory, cloud storage, or network accessible storage (NAS), etc. The touch panel 407 may include any suitable type of touch panel, such as a capacitive or resistive touch panel. The display 409 may include any suitable type of display such as a liquid crystal display (LCD), a light-emitting diode (LED) display, or an active-matrix organic light-emitting diode (AMOLED) display. In some implementations, the touch panel 407 may be layered onto the display 409 to form a touchscreen 411. Although not shown, the computing device 400 may include additional (or alternative) input devices, such as a microphone, a keyboard, a mouse, etc.

In some implementations, the computing device 400 may be the same or similar to any of the client devices 140 or 340. Additionally or alternatively, in some implementations, the computing device 400 may be the same or similar to any of the computing devices 380. Additionally or alternatively, in some implementations, the computing device 400 may be the same or similar to any of the computing devices that might form the global platform 310.

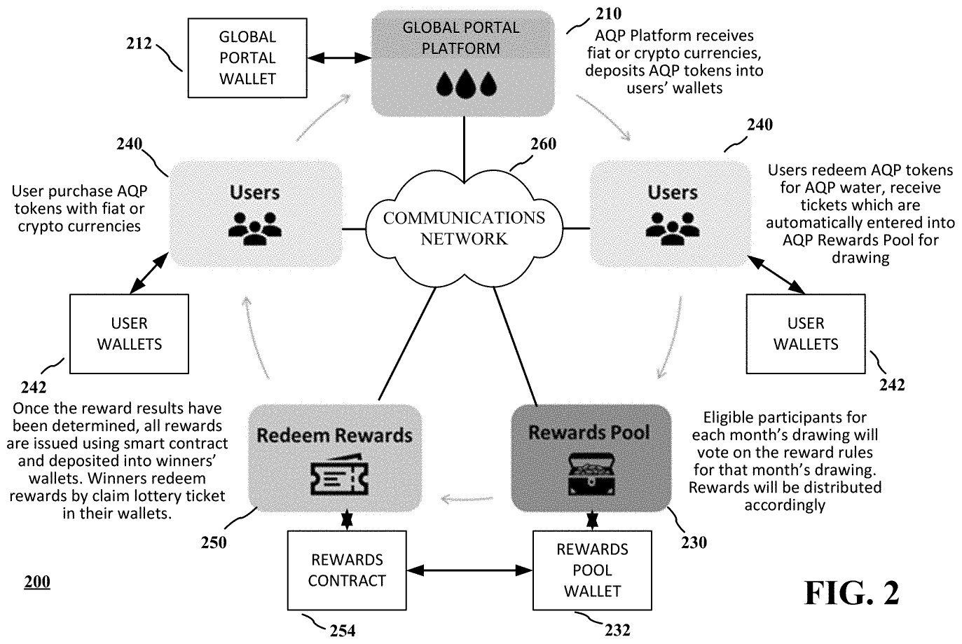

The system 100 may be configured to operate as part of a blockchain platform 200, an example of which is shown in FIG. 2. The blockchain platform may include a publicly managed blockchain platform (such as Ethereum or the like) or a privately managed platform (e.g., a blockchain controlled by a private entity). In some implementations, each of the computing devices 240 associated with users may be configured to mine and thereby validate transactions submitted to the blockchain platform. Similarly, any of the user or client devices 240 may also be configured to validate transactions submitted to the blockchain by communication network 260. Any of the client devices 240 may be configured to execute transactions on the blockchain platform. As is further discussed below, the transactions may include one or more of: (i) purchasing products, for example, bottled water, from Production Entity 120, (ii) receiving and redeeming fungible tokens with Production Entity and Fintech Entity 130, (iii) receiving drawing ticket(s) from Fintech Entity 130; (iv) redeeming rewards (e.g., having a winning ticket) that include benefits related to a percentage of ownership of shares in Production Entity 120. Each of the client devices 240 may be associated with a different user. Each user may have a user-specific wallet 242 coupled to a corresponding device 240.

The global platform 210 may be configured to provision a market-based game for the users of the client devices 140. In some implementations, the platform 210 may interface a plurality of users on the blockchain platform 210, and it may provide a number of products such as bottled water and allocate a corresponding fungible tokens for each user properly registered with the platform 210 through Production Entity 120, which the users of the client devices 140 can subsequently purchase and receive. In addition, the platform 210 may deploy logic (e.g., processor-executable instructions) on the blockchain platform 210, which when executed by the blockchain platform causes the blockchain platform to track the sales of the product, qualify a user in the platform who is considered to be eligible to receive and redeem fungible tokens to receive drawing tickets based on one or more rewards rules, and transmit the rewards in the wallets to users who have the winning tickets. In some implementations, the reward rules may provide that the user who has the winning tickets receives benefits in the form a NFT that relates to the stock shares of the Production Entity 120. However, the present disclosure is not limited to any specific rule for determining what rewards how a user may receive.

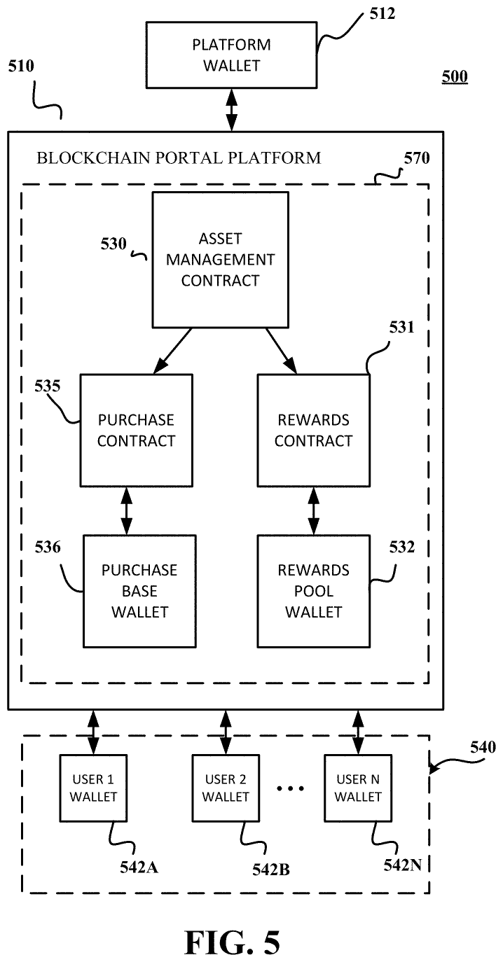

FIG. 5 is a diagram of a system 500 for practicing the present invention in one embodiment. In the present example, the system 500 is implemented in software that is executed on the system 300. However, in some implementations, the system 500 may be implemented in hardware. Furthermore, in some implementations, a portion of the system 500 may be implemented in hardware while another portion is implemented in software. In the latter case, the portion of the system 500 that is implemented in hardware may be integrated into one or more of the devices that form the system 300. Accordingly, it will be understood that the present disclosure is not limited to any specific implementation of the system 500.

The system 500 may include the blockchain platform 510, a plurality of digital wallets 542, and/or a platform wallet 512. In some implementations, the blockchain platform 510 may implement a distributed ledger that is available in its entirety to the participants in the blockchain platform (e.g., the computing devices, 380, the client devices 340 and/or the platform 510). Furthermore, the blockchain platform 510 may implement a peer-to-peer transaction mechanism that utilizes public-private key cryptography, has no central intermediary or central repository and allows all participants in the blockchain platform 510 to hold and validate a full copy of the ledger. In some implementations, the blockchain platform may be maintained by a public distributed network, such as the Ethereum network or the like. Additionally or alternatively, in some implementations, the blockchain platform 510 may be managed by a privately-managed network. Furthermore, the type of implementation of the blockchain platform 510 (e.g., the hashing process associated with proof of work and/or consensus protocol) may vary, as well, in different implementations of the system 500. Stated succinctly, the present disclosure is not limited to any specific implementation of the blockchain platform 510 and modifications made thereto would still be within the scope and spirit of the present disclosure.

Any of the wallets 542 may be a key store application which may include, store, and/or otherwise control at least one private key along with a public key that corresponds to the private key. These keys enable the signing of transactions on the blockchain platform and allow the client device of the user who owns the wallet to interact on behalf of the user with the blockchain platform. In some respects, controlling the private key represents control of an asset that is transacted using the public (or private) key, such as rewards or funds. Throughout the disclosure, references will be made to shares being “transferred” or “stored” in a wallet, even though in practice digital wallets do not actually store or hold assets. Accordingly, such references shall be interpreted as concerning transactions that are recorded on the blockchain platform by using any of the keys in the wallet. According to the present disclosure, a transaction is considered recorded on the blockchain platform 510 if a representation of that transaction has been validated and stored on the ledger of the blockchain platform 510.

In the present example, the wallet 542A is provided on the client device 340A or 540A and it represents the user of the client device 540A (i.e., user 1); the wallet 542B is provided on the client device 340B or 540B and it represents the user of the client device 340B (i.e. user 2); the wallet 542N is provided on the client device 540N, where N is an integer greater than 1, and it represents the user of the client device 540N (i.e. user N).

Although in the present example the wallets 542 are stored on the client devices 540, alternative implementations are possible in which the wallets are stored on the blockchain platform, and a respective image of each of the wallets 542 is stored on a different one of the client devices 540. It should also be noted that client devices 540 or 340A-N are referred to more generally as client devices 140 and wallets 542A-N are referred to more generally as wallets 542. It should be understood that there may be a greater or lesser number of client devices 540 and corresponding wallets 542 than those illustrated in the accompanying figures. Furthermore, alternative implementations are possible in which any of the wallets 542 is a hardware wallet. Stated succinctly, the present disclosure is not limited to any specific implementation of the wallets 542.

The platform wallet 512 may be a key store application which may include, store, and/or otherwise control at least one private key along with a public key that corresponds to the private key. In the present example, the platform wallet 512 is provided on the platform 510 and it represents an entity which owns the platform 510, such as Production Entity 120 and/or Fintech Entity 130. Although in the present example the platform wallet 512 is stored on the platform 510, alternative implementations are possible in which the platform wallet 512 is stored on the blockchain platform and an image of the wallet is stored on the platform 510. Furthermore, alternative implementations are possible in which the platform wallet 512 is implemented in hardware. Stated succinctly, the present disclosure is not limited to any specific implementation of the platform wallet 512 and that various modifications may be made thereto without departing from the scope and spirit of the present disclosure.

In some implementations, the blockchain platform may execute logic 570 for practicing the present invention. The logic 570 may be allocated on the blockchain platform by the platform 510. In the example of FIG. 5, the logic 570 is represented by contracts 530, 531 and 535. However, alternative implementations are possible in which the logic 570 is organized in another modular arrangement. For example, in some implementations, the entire logic 570 may be implemented using a single contract. Stated succinctly the present disclosure is not limited to any specific organization of the logic 570 for practicing the present invention as the specifically disclosed logic 570 is merely one illustrative, non-limiting example.

According to the present disclosure, any contract that is deployed on the blockchain platform may include processor-executable instructions that are executed and/or validated by one or more nodes in the blockchain platform. Any contract that is deployed on the blockchain platform may be viewed as an autonomous agent that is executed inside the environment of the blockchain platform always executing a specific code when triggered by a message or transaction and having a direct control over their own key store (e.g., wallet) to keep track of persistent variables. In some respect, implementing the present invention of distributing products and rewards using blockchain contracts is advantageous as it permits users to participate in the transactions without the need for a centralized broker or agent, resulting in increased scalability, transparency and trust in the transactions of product and rewards distribution conducted by executing the logic 570.

In some implementations, the logic 570 may allocate a plurality of products for each of the users to purchase. In some implementations, the product for any given one of the users may be allocated by executing (on the blockchain platform) a transfer transaction between the platform wallet 512 or purchase base wallet 536 and a wallet 542 associated with a given one of the users. After a number of product is purchased by a given one of the users, a corresponding number of fungible tokens may be allocated by the platform wallet 512 or purchase base wallet to a corresponding one of the user wallets 542. These tokens may be stored in the respective wallet 542 that is associated with that user.

In some implementations, the platform 510 may allocate a drawing ticket for wining a reward from a drawing that is periodically conducted using the logic 570. The rewards for the winning tickets may be allocated be executing (on the blockchain platform) a transfer transaction from the platform wallet 512 to the rewards pool wallet 532 or vice versa, which transfers electronic assets (e.g., a NFT and/or electronic funds and/or any other suitable representation of the rewards) into the user-specific wallet.

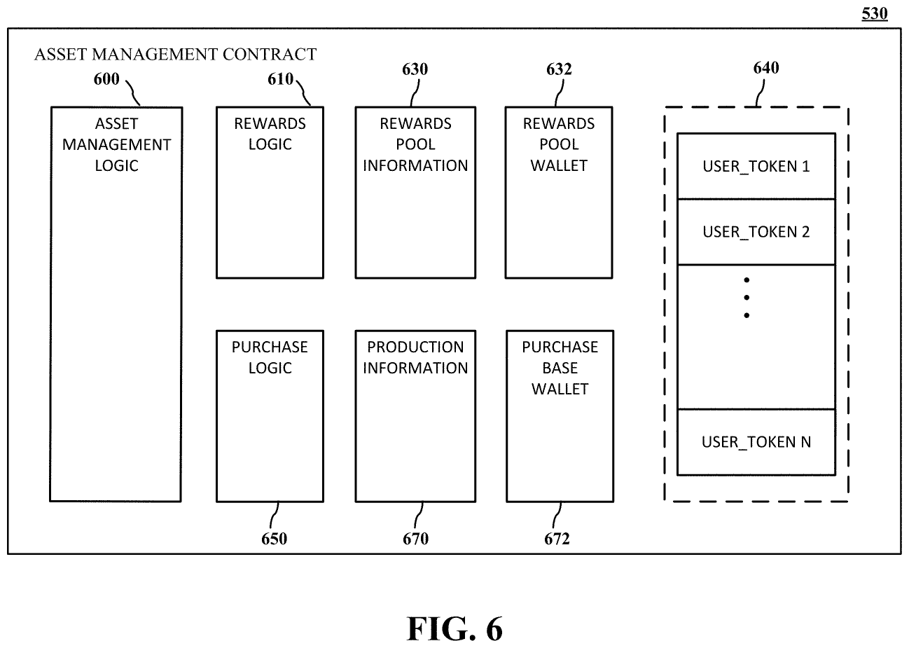

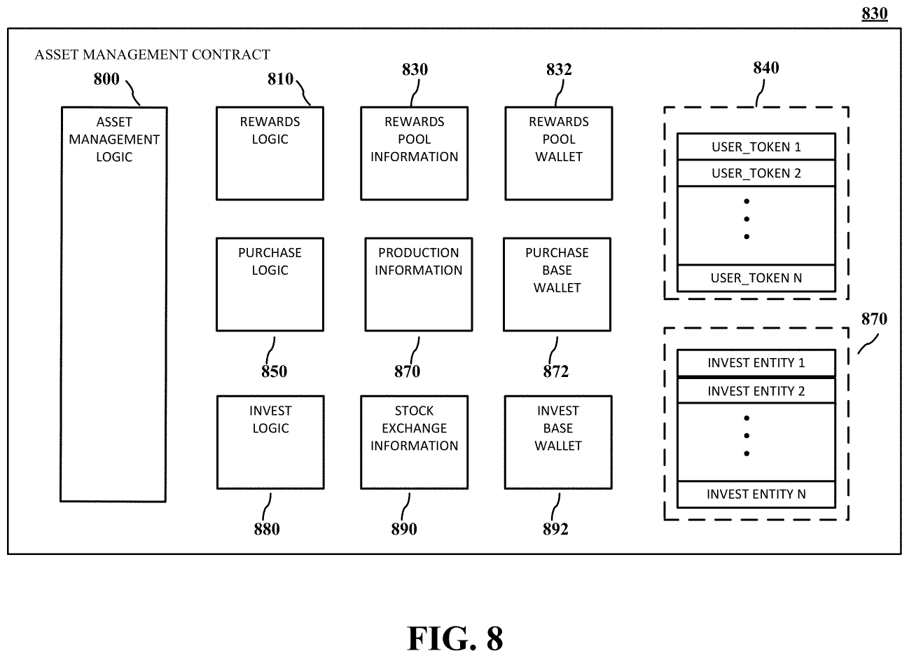

FIG. 6 provides an example, of one particular implementation of the logic 570, according to aspects of the disclosure. Shown in FIG. 6 is an example of the asset management contract 530, in accordance with one particular implementation. As illustrated, the asset management contract 530 may include an asset management logic 600, a rewards logic 610, a purchase logic 650, rewards pool information 630, product information 670, a rewards pool wallet 632, a purchase base wallet 672, and a plurality of tokens 640 which together define a pool of users 140 or 240. The asset management logic 600 may include one or more processor-executable instructions which when executed by one or more nodes in the blockchain platform cause the blockchain platform to perform the process 700, which is discussed further below with respect to FIG. 8. The rewards pool information 630 may include one or more data structures which include information regarding the rewards, NFTs, fungible tokens and users. The product information 670 may include one or more data structures which include information regarding the product and users. The purchase base wallet 672 may be a wallet which is used to store user information, and/or store the redeemable tokens. The rewards pool wallet 632 may be a wallet which is used to store user information, NFTs, and/or store the tokens 640 which define the users.

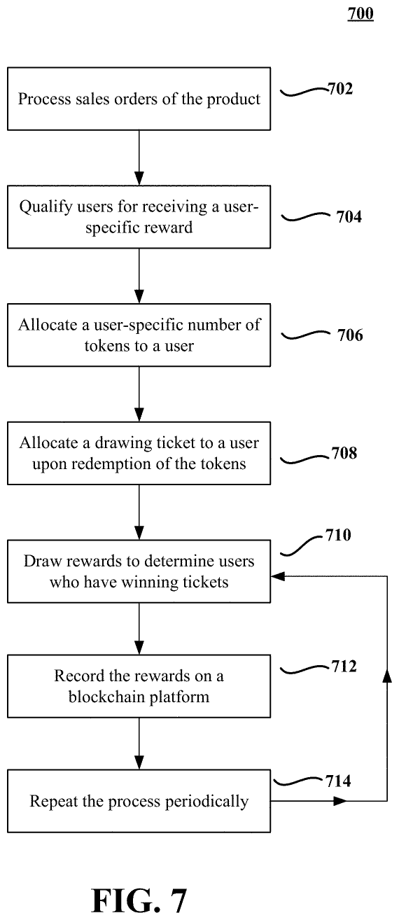

FIG. 7 is a flowchart of an example of a process 700 for rewarding users of a product with benefits related to the ownership of a Production Entity that sells the product on a blockchain platform, which is performed by the asset management contract 530 (and/or the asset management logic 600), according to aspects of the disclosure.

In one embodiment of the present invention, the method includes the steps of allocating on the blockchain platform with respect to the Production Entity, purchase logic including one or more processor-executable instructions, which when executed by at least one node in the blockchain platform, cause the node to register users to the blockchain platform. Then at step 702, the platform may process sales orders of the product from the users. The platform may then qualify users to determine the eligibility of each user for receiving a user-specific reward; at step 704. The platform may calculate a number P of the product to be delivered in a predetermined period of time, for example, in six months, based on the sales orders from the users. The Production Entity 120 then provide the number P of the product to Fintech Entity 130.

The Fintech Entity 130, by executing rewards logic including one or more processor-executable instructions, which when executed by at least one node in the blockchain platform cause the node to allocate a plurality of non-fungible tokens (NFTs) in total number N, each non-fungible token representing a percentage of stock ownership of the Production Entity, divide the plurality of non-fungible tokens into a first number N1 of NFTs and a second number N2 of NFTs, allocate, on the blockchain platform, the first number N1 of NFTs into a purchase base wallet 672 and the second number N2 of NFTs into a rewards pool wallet 632, respectively.

At step 706 and upon receiving the number P of the product from the Production Entity 120, the platform allocates a number of redeemable tokens corresponding to the number P of the product. Then the Production Entity 120 or Fintech Entity 130 allocates a user-specific number of redeemable tokens to a user based on the number of the product purchased by a user.

At step 708, the Fintech Entity 130 allocates a drawing ticket to a user upon a predetermined number of the redeemable tokens, for example 150 tokens corresponding to a monthly subscription of the bottled water or 150 bottles.

At step 710, a drawing is conducted by the platform to draw rewards in a rewards pool to determine users who have winning drawing tickets, according to reward rules, and the rewards are then recorded on the blockchain platform accordingly at step 712.

And once one or more winners are decided and rewards are distributed, the platform may execute a transaction on the blockchain platform providing a user-specific reward to a corresponding user wallet for each of the users who have winning drawing tickets, wherein at least one of the rewards has the benefits of stock shares corresponding to the ownership of the Production Entity.

At step 714, the steps 710-712 may be repeated periodically monthly, quarterly, or yearly.

In one embodiment of the present invention, the method further includes the step of allocating, on the blockchain platform, asset management logic 600 including one or more processor-executable instructions, which when executed by at least one node in the blockchain platform cause the node to execute purchase logic 650.

In one embodiment of the present invention, the method further includes the step of allocating, on the blockchain platform, asset management logic including one or more processor-executable instructions, which when executed by at least one node in the blockchain platform cause the node to execute reward logic 610.

In one embodiment of the present invention, the step of registering includes the step of allowing a user to open an account; requesting the user to provide user-specific health report from an medical professional service provider that includes personal health parameters measured and collected from the user related to the user's skin, organs, muscles, nerves, blood, etc.; and periodically requesting the user to provide up-to-date user-specific health report from an medical professional service provider that includes personal health parameters measured and collected from the user related to the user's skin, organs, muscles, nerves, blood, etc. to keep the account in good standing.

In one embodiment of the present invention, the step of processing sales orders comprises: allowing a user who has an account to put a purchase order with a specific amount of the product through the blockchain platform; completing the transaction corresponding to the purchase order with payment from the user using fiat or crypto currencies through the blockchain platform; issuing a receipt for the purchase order to the user wallet after the payment from the user using fiat or crypto currencies is deposited into a purchase base wallet from the user wallet; and storing a corresponding smart contract in a decentralized ledger.

In one embodiment of the present invention, the step of qualifying comprises: comparing the number of the products purchased by a user against a predetermined numerical threshold to determine whether the user is qualified to receive a user-specific reward, wherein only when the number of the products purchased by a user is equal or greater than the predetermined numerical threshold, a user is qualified to receive a user-specific reward.

In one embodiment of the present invention, the product is bottled water, and the predetermined numerical threshold equals to a number of the bottled waters to be consumed by a user in a predetermined period of time.

In one embodiment of the present invention, the step of allocating a user-specific number of redeemable tokens comprises: allocating a user-specific number of redeemable tokens to a qualified user equals to the number of the products purchased by the qualified user, wherein the amount of the redeemable tokens that a qualified user can receive in a predetermined time period from the blockchain platform is unlimited.

In one embodiment of the present invention, the step of allocating a drawing ticket to a user upon a predetermined number of the redeemable tokens comprises: receiving a request from the user to redeem a user-specific number of redeemable tokens; dividing the user-specific number of redeemable tokens of a user by the predetermined number of the redeemable tokens to generate an integer I; comparing the integer I against a predetermined limit integer M; allocating I drawing tickets to the user if I≤M; and allocating M drawing tickets to the user if I>M.

In one embodiment of the present invention, wherein once a user redeems a user-specific number of redeemable tokens, the redeemed tokens are collected and then destroyed in rewards pool wallet.

In one embodiment of the present invention, wherein the reward rules for the drawing are predetermined or voted by eligible participants of that drawing.

In one embodiment of the present invention, wherein the drawing is conducted periodically.

In one embodiment of the present invention, wherein the first number N1 of NFTs and the second number N2 of NFTs satisfy the following conditions:

N1+N2=N, and N1<N2.

In one embodiment of the present invention, the method further includes the step of: auctioning the first number N1 of NFTs; depositing proceeds from the auctioning to the purchase base wallet; and storing transaction for each NFT auctioned on a decentralized ledger.

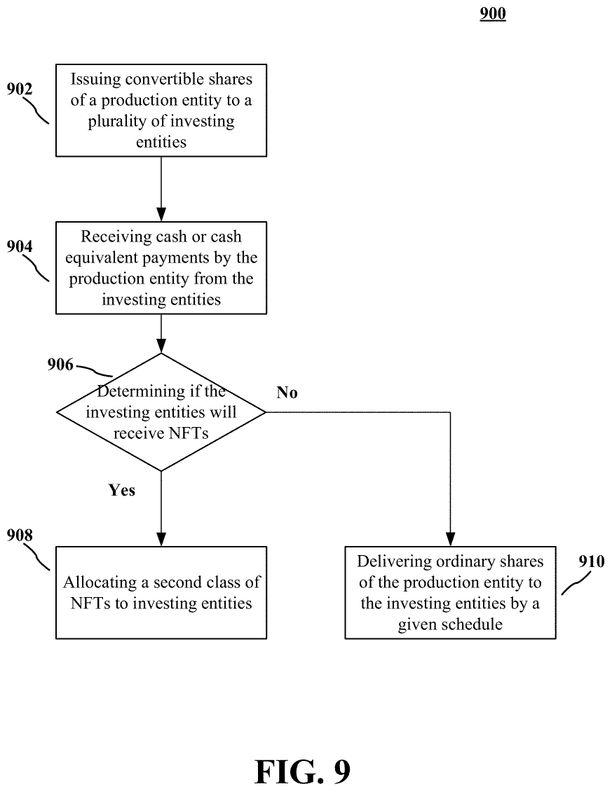

In one embodiment of the present invention, a process 900 is provided in connection with a contract 830 is executed with invest logic 880, referring now to FIG. 8 and FIG. 9 respectively.

At step 902, the production entity 120, at the beginning of a first predetermined time period tᵢ, time Tₒ, issues a number N_{cs} of convertible preference shares to a plurality of investing entities 870, wherein the N_{cs} convertible shares are convertible to N_{cs} ordinary shares of the production entity investing entities over a period of time T counting from time Tₒ, calculating the number N_{cs} according to the following formula:

N_{cs}=(PAE×L)/SPₒ,
wherein the ordinary shares of the production entity are publicly traded in a capital market, the period of time T is divided into a predetermined number L of the first predetermined time period ti such that T=L×tᵢ, PAE is the projected annual after-tax earning that the production entity would make from the sales of the product as well as auctioning the first number N1 of NFTs over the period of time T, and SPₒ is the stock price per share for the ordinary shares of the production entity averaged over a second predetermined time period t₂ around time Tₒ.

At step 904, the production entity 120 receives cash or cash equivalents payments from the plurality of investing entities, wherein the cash or cash equivalents payment are made by the investing entities for the convertible shares, respectively.

The invest logic aggregates in every first predetermined time period tᵢ over the period of time T by the platform all the cash or cash equivalents payments received from the investing entities into a first amount, {M₁ᵢ, i=1, . . . , L}; calculating the after-tax earning that the investing entities would make from the cash or cash equivalents payments investing in capital markets over the ith first predetermined time period t₁; when cash or cash equivalents payments are made by the production entity to the plurality of investing entities, aggregating all the cash or cash equivalents made in a second amount, {M₂ᵢ, i=1, . . . L}, in every first predetermined time period tᵢ over the period of time T, wherein M₁ᵢ and M₂ᵢ satisfy the following relationships:

M₂ᵢ<M₁ᵢ, and

(M₁ᵢ−M₂ᵢ)×(1−Rtax)=Eᵢ;
making book entries by at least one node on the platform for all the cash or cash equivalents payments received and storing corresponding records of the book entries in the decentralized ledger;
calculating a maximum number Nᵣₛ, which is determined by the following formula:

Nᵣₛ=Σ^{L}ᵢ₌₁N_{cs}(i)×αᵢ
where {αᵢ} satisfy the condition of Σ^{L}ᵢ₌₁αᵢ≤1, and the number of N_{cs} convertible preference shares issued to the plurality of investing entities converted to a number of ordinary shares of the production entity over the period of time T is no greater than the maximum number Nᵣₛ; and
when a number of ordinary shares of the production entity is delivered to the investing entities, making book entries by at least one node on the platform for the delivered ordinary shares of the production entity and storing corresponding records of the book entries in the decentralized ledger.

In one embodiment of the present invention, the investing entities have a choice whether to receive number of ordinary shares of the production entity or not at step 906. If not, at step 908, instead of receiving a number of ordinary shares of the production entity by the investing entities: they receive a plurality of a second class of non-fungible tokens (NFTs) in total number X, each non-fungible token representing a percentage of stock ownership of the production entity in the form of convertible preference shares; and allocating, on the blockchain platform, a number of the second class NFTs into an investing entity specific wallet for each of the investing entities, respectively, in lieu of the cash or cash equivalents payments. These second class of non-fungible tokens (NFTs) can be considered as “Stablecoin”.

FIGS. 1-9 are provided to illustrate a particular implementation of the present disclosure and not intended to limit the disclosure. It will be understood that any of the steps in the processes 700 and 900 may be performed concurrently with other steps in those processes and altogether omitted. It will be further understood that the provision of the examples described herein, as well as clauses prefaced with “such as,” “e.g.”, “including”, “in some aspects,” “in some implementations,” and the like should not be interpreted as limiting the disclosed subject matter to the specific examples.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

What is claimed is:

1. A method for rewarding users of a product with benefits related to ownership of a Production Entity that sells the product on a blockchain platform, comprising:
allocating on the blockchain platform with respect to the Production Entity, purchase logic including one or more processor-executable instructions, which when executed by at least one node in the blockchain platform, cause the node to:
register users to the blockchain platform;
process sales orders of the product from the users;
qualify the users to determine the eligibility of each user for receiving a user-specific reward;
calculate a number P of the product to be delivered in a predetermined period of time based on the sales orders from the users; and
provide the number P of the product to a Fintech Entity;
allocating on the blockchain platform with respect to the Fintech Entity, rewards logic including one or more processor-executable instructions, which when executed by at least one node in the blockchain platform cause the node to:
allocate a plurality of non-fungible tokens (NFTs) in total number N, each non-fungible token representing a percentage of stock ownership of the Production Entity;
divide the plurality of non-fungible tokens into a first number N1 of NFTs and a second number N2 of NFTs;
allocate, on the blockchain platform, the first number N1 of NFTs into a purchase base wallet and the second number N2 of NFTs into a rewards pool wallet, respectively, and
upon receiving the number P of the product from the Production Entity, allocate a number of redeemable tokens corresponding to the number P of the product;
allocating a user-specific number of redeemable tokens to a user based on the number of the product purchased by a user;
allocating a drawing ticket to a user upon a predetermined number of the redeemable tokens;
drawing rewards in a rewards pool to determine users who have winning drawing tickets, according to reward rules; and
executing a transaction on the blockchain platform providing a user-specific reward to a corresponding user wallet for each of the users who have winning drawing tickets, wherein at least one of the rewards has the benefits of stock shares corresponding to the ownership of the Production Entity.

2. The method of claim 1, comprising a step of allocating, on the blockchain platform, asset management logic including one or more processor-executable instructions, which when executed by at least one node in the blockchain platform cause the node to execute purchase logic.

3. The method of claim 1, comprising a step of allocating, on the blockchain platform, asset management logic including one or more processor-executable instructions, which when executed by at least one node in the blockchain platform cause the node to execute reward logic.

4. The method of claim 1, wherein the step of registering comprises:
allowing a user to open an account;
requesting the user to provide user-specific health report from an medical professional service provider that includes personal health parameters measured and collected from the user related to the user's body tissues; and
periodically requesting the user to provide up-to-date user-specific health report from an medical professional service provider that includes personal health parameters measured and collected from the user related to the user's body tissues to keep the account in good standing.

5. The method of claim 1, wherein the step of processing sales orders comprises:
allowing a user who has an account to put a purchase order with a specific amount of the product through the blockchain platform;
completing the transaction corresponding to the purchase order with payment from the user using fiat or crypto currencies through the blockchain platform;
issuing a receipt for the purchase order to the user wallet after the payment from the user using fiat or crypto currencies is deposited into a purchase base wallet from the user wallet; and
storing a corresponding smart contract in a decentralized ledger.

6. The method of claim 1, wherein the step of qualifying comprises:
comparing the number of the products purchased by a user against a predetermined numerical threshold to determine whether the user is qualified to receive a user-specific reward, wherein only when the number of the products purchased by a user is equal or greater than the predetermined numerical threshold, a user is qualified to receive a user-specific reward.

7. The method of claim 6, wherein the product is bottled water, and the predetermined numerical threshold equals to a number of the bottled waters to be consumed by a user in a predetermined period of time.

8. The method of claim 7, wherein the step of allocating a user-specific number of redeemable tokens comprises:
allocating a user-specific number of redeemable tokens to a qualified user equals to the number of the products purchased by the qualified user, wherein the amount of the redeemable tokens that a qualified user is capable of receiving in a predetermined time period from the blockchain platform is unlimited.

9. The method of claim 8, wherein the step of allocating a drawing ticket to a user upon a predetermined number of the redeemable tokens comprises:
receiving a request from the user to redeem the user-specific number of redeemable tokens;
dividing the user-specific number of redeemable tokens of a user by the predetermined number of the redeemable tokens to generate an integer I;
comparing the integer I against a predetermined limit integer M;
allocating I drawing tickets to the user if I≤M; and
allocating M drawing tickets to the user if I≥M.

10. The method of claim 9, wherein once a user redeems a user-specific number of redeemable tokens, the redeemed tokens are collected and then destroyed in rewards pool wallet.

11. The method of claim 1, wherein the reward rules for the drawing are predetermined or voted by eligible participants of that drawing.

12. The method of claim 11, wherein the drawing is conducted periodically.

13. The method of claim 1, wherein the first number N1 of NFTs and the second number N2 of NFTs satisfy the following conditions:
N1+N2=N, and N1<N2.

14. The method of claim 13, further comprising the steps of:
auctioning the first number N1 of NFTs;
depositing proceeds from the auctioning to the purchase base wallet; and
storing transaction for each NFT auctioned on a decentralized ledger.

15. The method of claim 14, further comprising the steps of:
issuing by the Production Entity, at the beginning of a first predetermined time period time Tᵢ, a number N_{cs} of convertible preference shares to a plurality of investing entities, wherein the N_{cs} convertible shares are convertible to N_{cs} ordinary shares of the Production Entity investing entities over a period of time T counting from time Tₒ, calculating the number N_{cs} according to the following formula:
N_{cs}=(PAE×L)/SPₒ,
wherein the ordinary shares of the Production Entity are publicly traded in a capital market, the period of time T is divided into a predetermined number L of the first predetermined time period tᵢ such that T=L×tᵢ, PAE is the projected annual after-tax earning that the Production Entity would make from the sales of the product as well as auctioning the first number N1 of NFTs over the period of time T, and SPₒ is the stock price per share for the ordinary shares of the Production Entity averaged over a second predetermined time period t₂ around time Tₒ;
receiving cash or cash equivalents payments by the Production Entity from the plurality of investing entities, wherein the cash or cash equivalents payment are made by the investing entities for the convertible shares, respectively;
aggregating in every first predetermined time period ti over the period of time T by the platform all the cash or cash equivalents payments received from the investing entities into a first amount, {M₁ᵢ, i=1, . . . , L};
calculating the after-tax earning that the investing entities would make from the cash or cash equivalents payments investing in capital markets over the ith first predetermined time period t₁;
when cash or cash equivalents payments are made by the Production Entity to the plurality of investing entities, aggregating all the cash or cash equivalents made in a second amount, {M₂ᵢ, i=1, . . . L}, in every first predetermined time period tᵢ over the period of time T, wherein M₁ᵢ and M₂ᵢ satisfy the following relationships:
M₂ᵢ<M₁ᵢ, and
(M₁ᵢ−M₂ᵢ)×(1−Rtax)=Eᵢ;
making book entries by at least one node on the platform for all the cash or cash equivalents payments received and storing corresponding records of the book entries in the decentralized ledger;
calculating a maximum number Nᵣₛ, which is determined by the following formula:
Nᵣₛ=Σ^{L}ᵢ₌₁N_{cs}(i)×αᵢ
where {αᵢ} satisfy the condition of Σ^{L}ᵢ₌₁αᵢ≤1, and the number of N_{cs} convertible preference shares issued to the plurality of investing entities converted to a number of ordinary shares of the Production Entity over the period of time T is no greater than the maximum number Nᵣₛ; and
when the number of ordinary shares of the Production Entity is delivered to the investing entities, making book entries by at least one node on the platform for the delivered ordinary shares of the Production Entity and storing corresponding records of the book entries in the decentralized ledger.

16. The method of claim 15, wherein instead of receiving a number of ordinary shares of the Production Entity by the investing entities, further comprising the steps of:
allocating a plurality of a second class of non-fungible tokens (NFTs) in total number X, each non-fungible token representing a percentage of stock ownership of the Production Entity in the form of convertible preference shares; and
allocating, on the blockchain platform, a number of the second class of NFTs into an investing entity specific wallet for each of the investing entities, respectively, in lieu of the cash or cash equivalents payments.

17. The method of claim 1, wherein the blockchain platform includes a plurality of nodes that are coupled to one another via a communications network, each node including a processor operatively coupled to a memory and configured to execute at least one of the purchase logic and the rewards logic.

18. A method for rewarding users with ownership of a company in a form of stocks, comprising:
issuing, by an asset management unit, a number of fungible tokens according to a number of products related to the company in a predetermined period of time provided by the company;
distributing the fungible tokens into wallets of users who purchase one of the products of the company from a blockchain platform;
issuing drawing tickets to the wallets of the users who redeem the fungible tokens, wherein the drawing tickets are automatically entered into a rewards pool for drawing;
drawing rewards in the rewards pool to determine winners from the users who have the drawing tickets, according to reward rules; and
issuing the rewards using smart contracts and depositing the rewards into wallets of the winners, wherein the winners redeem the rewards by claiming the drawing tickets in their wallets.

19. The method of claim 18, further comprising:
creating a limited series of non-fungible tokens (NFTs) including a first number of NFTs and a second number of NFTs, wherein each of the first number of NFTs and the second number of NFTs is associated with a percentage of the ownership of the company in the form of stocks and includes a subscription of the product for a predetermined period of time.

20. The method of claim 19, wherein the first number of NFTs are available for sale by auction, and the second number of NFTs are not available for sale and only available as the rewards through participation in the rewards pool.

21. The method of claim 20, wherein the second number of NFTs are stored in the rewards pool.

22. The method of claim 19, wherein said distributing the fungible tokens comprises:
redeeming, by the users, a proper amount of the fungible tokens to receive at least one drawing ticket to participate in the rewards pool for receiving one of the second number of NFTs if winning.

23. The method of claim 19, wherein said distributing the fungible tokens comprises:
purchasing, by the users, a predetermined number of the products with fiat or crypto currencies through the blockchain platform, wherein the blockchain platform receives the fiat or crypto currencies and deposits the fungible tokens into the wallets of the users.

24. The method of claim 18, wherein the amount of the fungible tokens that each user is capable of having through buying the products per month on the blockchain platform is unlimited, while each user is only permitted to redeem a predetermined number of the fungible tokens per month.

25. The method of claim 18, wherein the reward rules for the drawing in each month are predetermined or voted by eligible participants of that month.

26. The method of claim 18, wherein once a user redeems a number of the fungible tokens, the asset management unit collects the redeemed tokens and destroys them.

27. The method of claim 18, wherein the smart contracts are stored on a decentralized ledger.
